(19) United States
(12) Patent Application Publication
(10) Pub. No.: US 2003/0200267 A1
(43) Pub. Date: Oct. 23, 2003

(54) Email management system

(76) Inventor: James F. Garrigues, Dallas, TX (US)

Correspondence Address: ROBERT C. KOWERT, CONLEY, ROSE & TAYON, P.C., P.O. BOX 398, AUSTIN, TX, 78767-0398, US

(21) Appl. No.: 10/127,520

(22) Filed: Apr. 22, 2002

(51) Int. Cl. G06F 15/16; G06F 12/14; G06F 11/30; H04L 9/32; H04L 9/00

(52) U.S. Cl. 709/206; 713/200; 709/229

(57) ABSTRACT

An email system for controlling unsolicited email may include a server to manage email messages. The server may be configured to receive an email message from a sender. The email message may include a destination address of an email client and may include a code. If the included code is not a valid authorization code, the email server may not provide the email message to the email client. A request code for requesting an authorization code may be provided to the sender. If the email server receives an email message including the request code from the email sender, the email server may provide a portion of the email message to the email client for determining whether or not to provide an authorization code to the email sender.

### BACKGROUND OF THE INVENTION

1. Field of the Invention

This invention relates to email, and more particularly to controlling unsolicited email.

2. Description of the Related Art

FIG. 1 illustrates a typical email management system. Email server 150, email senders 160, and email clients 170 may couple via network 10. Network 10 may be a wired or wireless network or a combination thereof, and may include a LAN (Local Area Network), WAN (Wide Area Network), Internet, or a combination thereof. Any of a variety of one or more networking protocols may be used in network 10, for example, TCP/IP (Transmission Control Protocol/Internet Protocol). In one embodiment, email server 150 may include a network email server application (e.g. sendmail™) operating according to a communication protocol such as, for example, SMTP (Simple Mail Transfer Protocol). In one embodiment, email senders 160 may include, but are not be limited to, other email servers and/or email client applications (e.g. Microsoft Outlook™). In one embodiment, email clients 170 may include, but are not be limited to, other email servers and/or email client applications. Email server 150 may receive one or more email messages from one or more email senders 160. Email server 150 may provide the one or more email messages to one or more email boxes 180. Email server 150 may use one or more email addresses 100 to determine which of the one or more email messages to provide to a particular email box 180. Email clients 170 may retrieve email messages from email boxes 180.

A typical email address may correspond to a user for receiving email messages. The email address may include an Internet email URL (Universal Resource Locator) including a username and a domain name delimited by the ‘@’ symbol (e.g. ‘john.smith@yourcompany.com’).

One current technique for preventing unsolicited email messages is to block the reception of email messages from particular email addresses. A client email application may block reception of email messages from particular email addresses using a filter to remove email messages received from the particular email addresses. Maintaining a list of unsolicited email senders is difficult and time consuming. For example, an unsolicited email sender may often change email addresses (typically with each new message).

Another current technique for preventing unsolicited email messages is to block the reception of email messages from particular network domain addresses. Email servers may consult databases of particular network domain addresses to block reception of email messages from entire network domains. However, doing so may prevent users from receiving valid email messages from email senders in the blocked domain. Typically, lists of email addresses and network domain addresses are maintained and consulted for each email message.

### SUMMARY OF THE INVENTION

An unsolicited email handler may be provided to filter out emails not including a valid authorization code. In one embodiment, codes may be affixed (e.g. prefixed or suffixed) to a username portion of an existing base email addresses. Codes may include authorization codes. Authorization codes may be provided to one or more email senders. An email sender may attach an authorization code to email messages for sending to the email client. Inclusion of a valid authorization code may indicate that the email message is not unsolicited email (e.g. a bulk advertisement or spam).

A system may include an email server that may receive an email message including a destination address from an email sender. In one embodiment, if the email message includes a valid authorization code associated with the destination address, the email server may send the email message to an email box associated with the destination address. An email client may then retrieve the email message from the email box. If the email message does not include an authorization code or includes an invalid code, the email server may not send the email message to the email box.

For emails lacking a valid authorization code, the email server may send a reply message to the email sender. In one embodiment, the reply message sent by the email server may include a request code. The request code may be valid for a limited time and, in one embodiment, the reply message may also include a time-to-live indicator for the request code. The reply message may include instructions on how to use the request code to request a valid authorization code.

If the email message includes a valid request code, the email server may send a portion of the email message to an email box corresponding to the destination address of the message. In one embodiment, the portion of the email message may be the email message stripped of a body and attachments, if any, before being viewed by an email user. The request code may be used by email senders to request authorization codes. In one embodiment, expired request codes may be stored to prevent new request codes from matching expired request codes.

A system may include a mechanism for managing email addresses and associated codes. In one embodiment, a database for storing email addresses and their associated codes may be provided. A user interface for the database may be provided to manage email addresses and their associated codes. For example, the user interface may be used to invalidate an authorization code and/or generate a new authorization code. In one embodiment, invalidated authorization codes may be stored to prevent new authorization codes from matching invalidated authorization codes. One embodiment may include a web-based interface with user authentication and/or encrypted communication for security.

### BRIEF DESCRIPTION OF THE DRAWINGS

FIG. 1 illustrates a typical email management system;

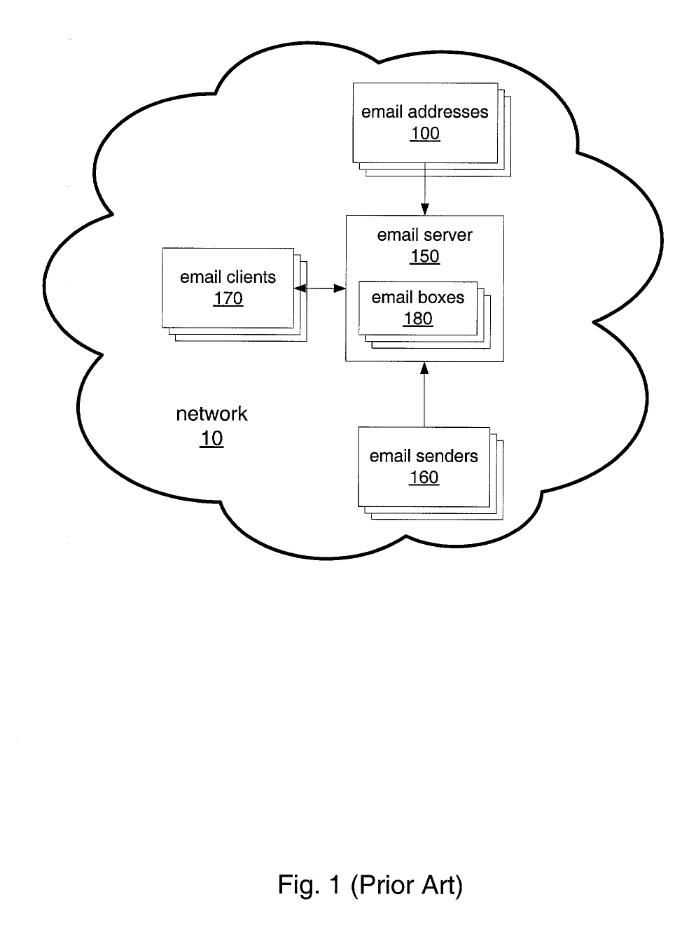

FIGS. 2A and 2B illustrate processing an email message including a valid authorization code according to one embodiment;

FIG. 3, one embodiment of an email message including an authorization code is illustrated;

FIGS. 4A and 4B illustrate processing an email message that does not include a valid authorization code according to one embodiment;

FIGS. 5A and 5B illustrate processing an email message that includes a request code according to one embodiment;

FIG. 6 illustrates one embodiment of an email client providing an authorization code to an email sender;

FIG. 7 illustrates one embodiment of a method for processing email messages to control unsolicited messages;

FIG. 8 illustrates one embodiment of a method for handling email messages that do not include valid authorization codes;

FIG. 9 illustrates one embodiment of a method for checking an email message for a valid code;

FIG. 10 illustrates one embodiment of handling a compromised authorization code; and

FIG. 11 illustrates one embodiment of a device, such as a server, configured to implement unsolicited email handler.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS OF THE INVENTION

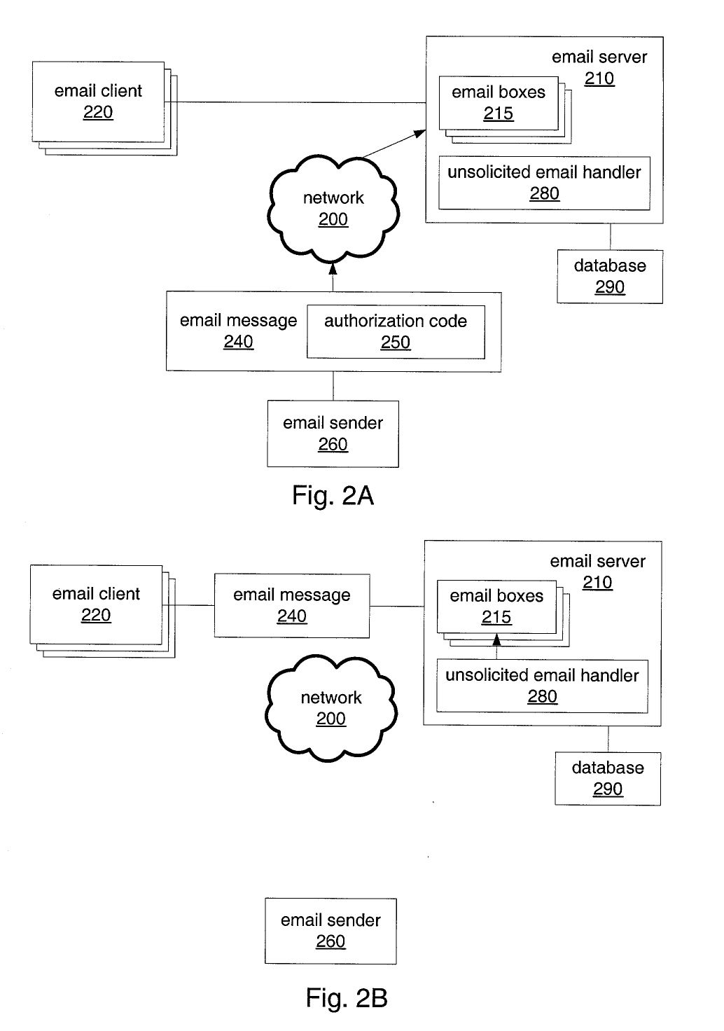

FIGS. 2A and 2B illustrate processing an email message including a valid authorization code according to one embodiment. Email clients 220, email server 210, and email sender 260 may couple via network 200. Network 200 may be a wired or wireless network or a combination thereof, and may include a LAN (Local Area Network), WAN (Wide Area Network), Internet, or a combination thereof. Any of a variety of one or more networking protocols may be used in network 200, for example, TCP/IP (Transmission Control Protocol/Internet Protocol). Email clients 220 and email sender 260 may be any of a variation of devices such as desktop personal computers, laptops, PDAs, point-of-sale terminals running client applications, and web-based email services (e.g. hotmail™). Email server 210 may be any variation of devices such as a LAN email server and a WAN email server running server applications for managing email. Email server 210 may include unsolicited email handler 280 and one or more email boxes 215. Each of the email boxes may correspond to an email address. The email clients 220 may retrieve email messages from the email boxes 215

Email sender 260 may have obtained authorization code 250 corresponding to an email address. The authorization code may have been provided to the email sender by the email address owner by email or non-email means (e.g. phone, fax, in person, etc.). In one embodiment, an owner of the email address may have provided authorization code 250 to email sender 260 in response to an email request message. In one embodiment, email sender 260 may include an email client application. The sender's email client application may include a list of email addresses (e.g. an address book). The email sender's client application may be operable to store authorized codes in the list for the email addresses. The user may enter an authorization code for one or more addresses in his address book. In one embodiment, a user of the email client application may select whether or not an authorization code should be automatically attached to an email address of an outgoing email message. In one embodiment, authorization code 250 may be attached (e.g. prefixed or suffixed) to the username portion of the email address. The email address may be included within a destination field of email message 240. As illustrated in FIG. 2A, email sender 260 may send email message 240 including authorization code 250. The message 240 may be routed across the network 200 according to normal email routing protocols. Email server 210 may receive email message 240 as the destination indicated by the domain portion of the email address.

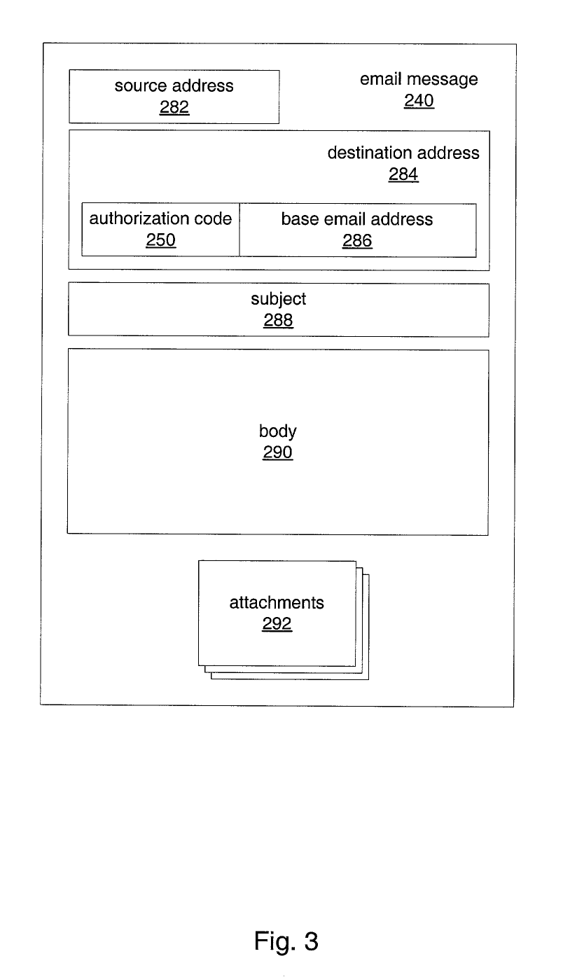

Turning briefly to FIG. 3, one embodiment of an email message including an authorization code is illustrated. Email message 240 may include source address 282. Source address 282 may indicate an email sender from which email message 240 was sent. Source address 282 may include an email address for the email sender formatted according to general format rules for typical email addresses (e.g. jane.doe@blog.org). Email message 240 may include destination address 284. Destination address 284 may include an email address corresponding to an intended recipient of email message 240. Destination address 284 may include authorization code 250 affixed to base email address 286.

In one embodiment, authorized code 250 may include one or more alphanumeric codes to be used as prefixes to base email address 286. In one embodiment, authorization code 250 may be three to eight digits long. In one embodiment, authorization code 250 may be delimited from base email address 286 by a period. For example, ‘41576’ may be an authorized code in the address ‘41576.john.smith@yourcompany.com’. In one embodiment, destination address 284 may meet general format rules for typical email addresses (e.g. according to internet universal resource locator standards). In other embodiments, authorized code 250 may be affixed at other positions of an email address and delimited from the email address by other symbols.

Email message 240 may include subject 288 and body 290. Subject 288 may include unformatted text (e.g. ASCII characters). Body 290 may include formatted (e.g. hypertext markup language) or unformatted (e.g. ASCII characters) text. Attachments 292 may include binary data, text or images, for example.

Turning back to FIGS. 2A and 2B, unsolicited email handler 280 of email server 210 may determine whether or not email message 240 includes a valid authorization code 250 for the base email address. In one embodiment, unsolicited email handler 280 may determine that email message 240 includes authorization code 250 by parsing authorization code 250 and the email address from the destination field of email message 240. In one embodiment, email server 210 may be coupled to database 290 storing one or more email addresses and their associated authorization codes. Unsolicited email handler 280 may locate the email address in database 290 and compare authorization code 250 to the email address's associated authorization codes from database 290.

In one embodiment, each email address owner may choose one or more authorized codes to associate with the particular email address owner's corresponding email address. In another embodiment, one or more authorized codes may be generated for each email address owner (e.g. randomly). In one embodiment, the email address owner may disable the use of codes, and the unsolicited email handler may simply pass through email messages to an email box when authorization codes for an email address corresponding to the email box are disabled.

Upon determining that email message 240 includes an authorization code 250 that is a valid authorization code, unsolicited email handler 280 may send email message 240 to the email box 215. Unsolicited email handler 280 may prevent email senders from sending unsolicited email messages to the email box 215 by disposing of email messages that do not include a valid authorization code for the email address corresponding to email box 215. In some embodiments, unsolicited email handler 280 may dispose of email messages that do not include valid authorization codes by deleting the email messages and/or sending response messages to email senders corresponding to the email messages. The response message may indicate to the sender that an authorization code is needed to email the addressee of the sender's email. The response message may include instructions for obtaining an authorization code. In one embodiment, unsolicited email handler may detect multiple email messages with no or invalid authorization codes and block or delete further messages from that source without sending the response message.

One embodiment may include a mechanism for managing email addresses and associated authorization codes. The mechanism may include a user interface. In one embodiment, the user interface may include a web-based interface. In one embodiment, the user interface may include user authentication and/or encrypted communication for security. The mechanism may allow a user to generate one or more authorization codes. In one embodiment, for example, an email address owner may input a sequence of alphanumeric characters for authorization code 250. In another embodiment, the mechanism may randomly generate the sequence of alphanumeric characters. In one embodiment, the mechanism may be used to disable an existing authorization code 250. For example, the user may desire to disable a code in response to receiving an unsolicited email message including authorization code 250, e.g. if the code has been compromised. In one embodiment, disabled authorization codes may be stored for a period of time to help prevent new authorization codes from matching disabled authorization codes.

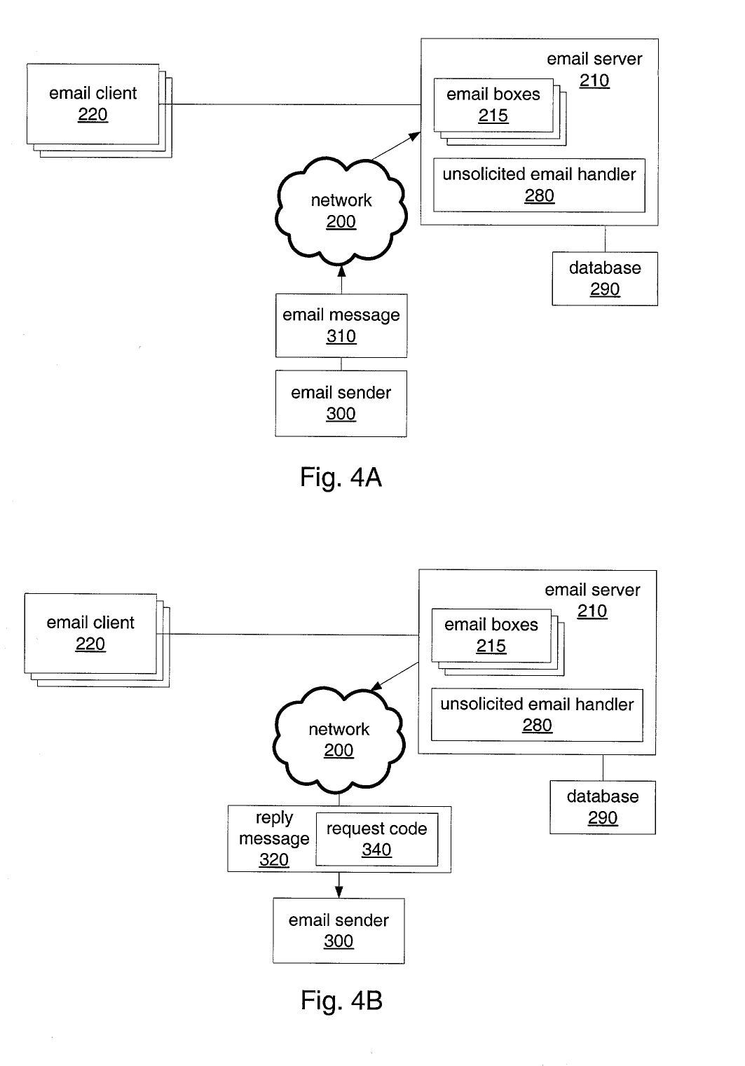

FIGS. 4A and 4B illustrate processing an email message that does not include a valid authorization code according to one embodiment. In FIG. 4A, email sender 300 may send email message 310 that does not include a valid authorization code corresponding to any email address of email boxes 215. For example, the destination address may include only an email address according to a typical Internet email URL (e.g. john.smith@yourcompany.com) or may include an invalid authorization code.

Referring to FIG. 4B, unsolicited email handler 280 may determine that email message 310 does not include a valid authorization code. In one embodiment, unsolicited email handler 280 may determine that email message 310 does not include a valid authorization code by parsing, for example, a user destination field of email message 310 to obtain a user destination address and any authorization code if present. Email server 210 may be coupled to database 290 storing email addresses and their associated authorized codes. Unsolicited email handler 280 may compare the destination address of email message 310 to the email addresses and their associated codes in database 290. Upon determining that the corresponding user has enabled authorization code checking and email message 310 does not include a valid authorization code, unsolicited email handler 280 may not provide email message 310 to email box 215. Instead, in one embodiment, email server 210 may send reply message 320 to email sender 300.

Reply message 320 may include request code 340. In one embodiment, request code 320 may be encoded within reply message 320 to help prevent a device or software application from automatically obtaining request code 340 from reply message 320. For example, request code 340 may be included in graphical form in an image as opposed to plain text. The encoding may help prevent automated unsolicited email senders from sending unsolicited email messages (e.g. advertisements) using request code 340.

Request code 340 may correspond to the email box 215 and may be used by email sender 300 to request an authorization code of an email address owner. In one embodiment, reply message 320 may include a time-to-live indicator indicating a length of time for which request code 340 is valid. If the time-to-live indicator expires, the expired request code may no longer be valid. In another embodiment, reply messages may not include the time-to-live indicator. In such embodiments, the unsolicited email handler may still only recognize a request code as valid for a limited amount of time. In one embodiment, database 290 may store request codes each associated with a stored email address.

In one embodiment, only a single request code 120 may be associated with any particular email address stored in database 290. In another embodiment, each email address may be associated with one or more request codes. In one embodiment, a request code may include one or more alphanumeric digits to be used as prefixes (or suffixes) to the username portion of the particular email address. In one embodiment, the request code may be three to eight digits long. In one embodiment, the request code may be delimited from the email address by a period. In one embodiment, for example, ‘abc772’ may be a request code in the address ‘abc772.john.smith@yourcompany.com’. In one embodiment, email addresses with affixed codes may still meet general format rules for typical email addresses (e.g. according to internet universal resource locator standards). In other embodiments, a request code may be affixed at other positions of an email address and delimited from the email address by other symbols. In one embodiment, a request code associated with an email address may be guaranteed not to match any authorization codes associated with the email address. In one embodiment, an email address owner corresponding to the email address may choose the request code. In another embodiment, the request code may be generated for the email address (e.g. randomly). In still another embodiment, to ensure that a randomly generated request code does not match an authentication code, the email address owner may choose the first two alphanumeric digits of a request code from among digits that do not match the first two alphanumeric digits of any authorization codes corresponding to the email address. The remaining digits (e.g. six more digits) of the request code may be generated (e.g. randomly).

In one embodiment, a time-to-live indicator may be associated with each request code. The time-to-live indicator may indicate a time at which the corresponding request code expires. In one embodiment, if the time indicated by the time-to-live indicator is reached, a new request code that does not match any corresponding authorized codes may be generated to replace the request code. In another embodiment, the new request code that does not match any corresponding authorized codes may be chosen by the corresponding email address owner. In still another embodiment, a portion of the new request code (e.g. the first two digits) may be chosen by the corresponding email address owner from among digits that do not match the first two digits of any corresponding authorized codes, and a remaining portion of the request code may be randomly generated. In one embodiment, the time-to-live indicator may be chosen by the corresponding email address owner. In another embodiment, the time-to-live indicator may be generated. In still another embodiment, the time-to-live indicator may be set to a pre-defined default value.

In one embodiment, database 290 may store codes specific to each one of a number of email addresses. Each email address corresponding to one of email boxes 215 may have one or more corresponding authorization codes and a corresponding request code. In one embodiment, database 290 may include a relational database system. In one embodiment, the database may include two types of tables. In one embodiment, for example, a first type of table may include a field for indicating an email address to which the table pertains. The first table may include an enable field. The enable field may indicate whether codes are to be enabled for that email address. If codes are not enabled for an email address, unsolicited email handler 280 may pass through all email messages to the appropriate email box 215 and email server 210 may function as a typical email server, for example, an SMTP (simple mail transfer protocol) compliant email server. The first table may include a time-to-live value for a request code. A request-only field of the first table may indicate two alphanumeric digits with which to begin request codes. The first table may include a timestamp field indicating a date of creation of each email address record. An example of one embodiment of a schema for the first table follows.

table name: config

a. fields: email (varchar) primary key, unique indexed

i. enable (boolean)

ii. request-only (char*2)

iii. time_to_live (integer)

iv. timestamp (date)

In one embodiment, a second table may store codes (e.g. a request code and one or more authorization codes) for each email address. In one embodiment, the second table may include a code field for storing codes. The second table may include a request field for indicating whether each code is an authorization code or a request code. The second table may include a valid field for indicating whether each code has been disabled or not. In one embodiment, disabled codes may be stored to help prevent new codes from coinciding with disabled codes. In one embodiment, the second table may include a comment field for indicating miscellaneous information such as, for example, a list of email senders that have been provided with each code. In one embodiment, the email address may relate the first table and the second table. An example of one embodiment of a schema for the second table follows.

table name: codes

a. fields: email (varchar) primary key

i. code (varchar*8)

ii. request (boolean)

iii. valid (boolean)

iv. comment (varchar)

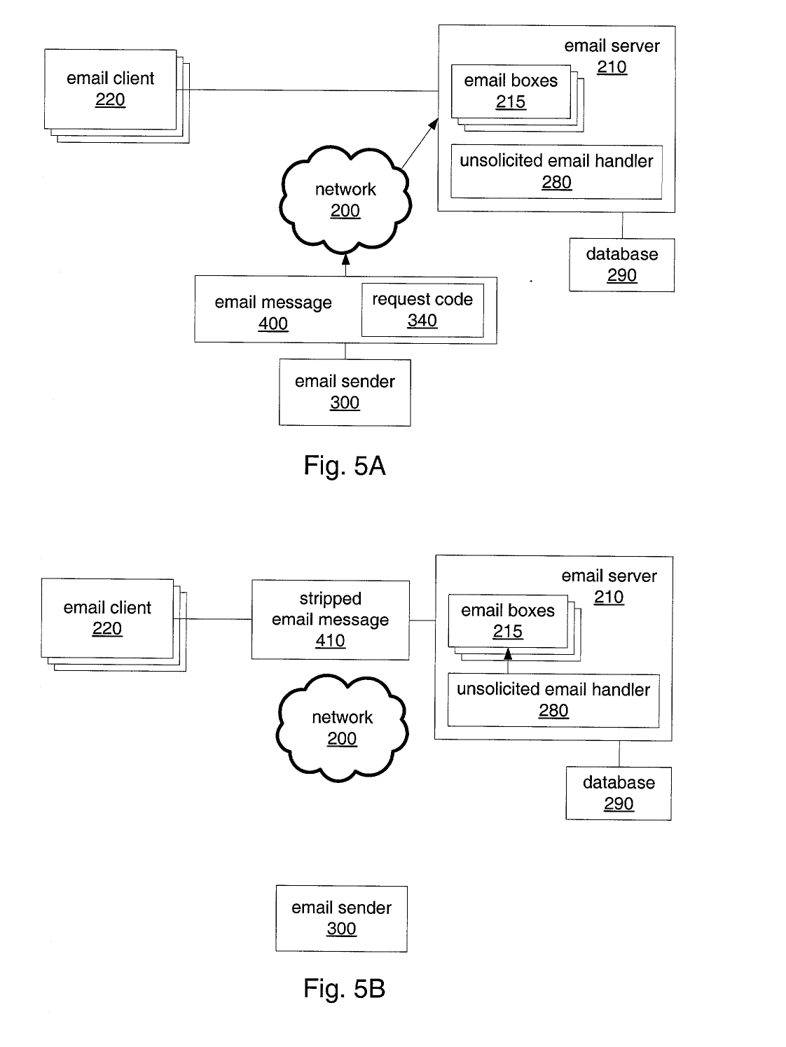

FIGS. 5A and 5B illustrate processing an email message that includes a request code according to one embodiment. In FIG. 5A, email sender 300 may send email message 400 including request code 340 to an email address corresponding to an email box 215. Unsolicited email handler 280 may receive email message 400 and determine that email message 400 includes request code 340, for example, by accessing database 290 that may store one or more codes corresponding to the email address. Unsolicited email handler 280 may access database 290 to determine if the request code is valid. If the request code is invalid, the message may be deleted or ignored. If the request code is valid, in one embodiment, unsolicited email handler 280 may strip email message 400 of a body and attachments, if any. Referring to FIG. 5B, unsolicited email handler 280 may send stripped email message 410 to the addressed email box 215. In one embodiment, unsolicited email handler 280 may send only a subject and a source address of email message 410 to the email box 215. In one embodiment, the email address owner of the email box 215 may use the subject and the source address to determine whether to provide email sender 300 with an authorization code.

This method of providing and processing request codes may allow previously unknown email senders to request authorization codes for sending email messages to email clients. The time-to-live indicator may help prevent email senders from abusing request codes, for example, by providing or selling the request code to other email senders.

One embodiment of the unsolicited email handler may include a mechanism for managing email addresses and associated request codes for email clients. The mechanism may include a user interface for the database. In one embodiment, the user interface may include a web-based interface. Through the user interface, a user may be able to directly or indirectly edit fields in tables, such as those described above, to manage his authorization and/or request codes. In one embodiment, the user interface may include user authentication and/or encrypted communication for security. Using the mechanism, a user may generate request code 340. In one embodiment, for example, the user may input a sequence of alphanumeric characters for request code 340. In another embodiment, the mechanism may randomly generate the sequence of alphanumeric characters. In one embodiment, using the mechanism, the user may generate the time-to-live indicator indicating a length of time for which the code is valid. In another embodiment, the mechanism may assign the time-to-live indicator a pre-defined default value.

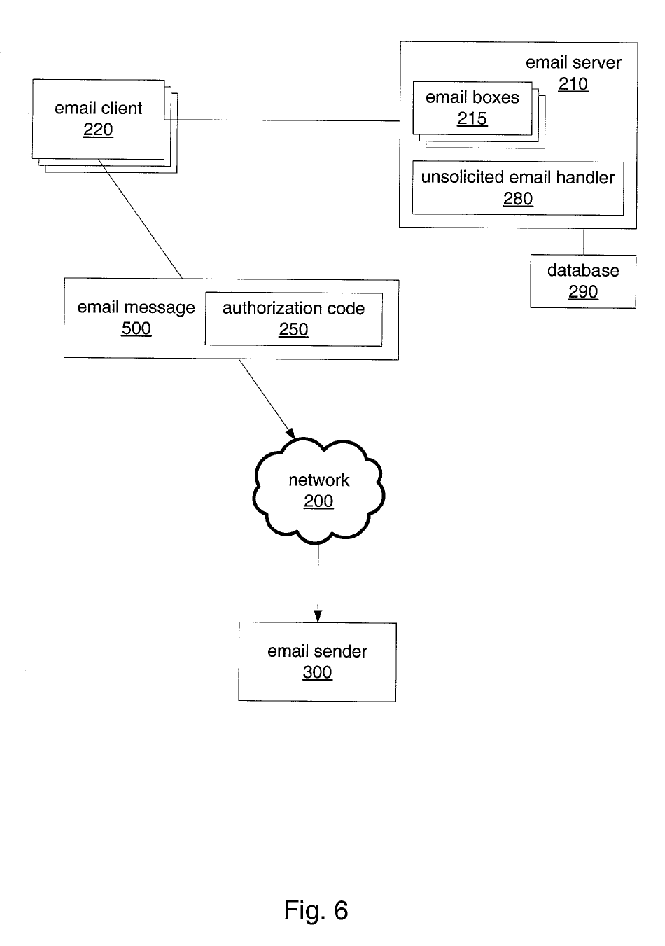

FIG. 6 illustrates one embodiment of an email client providing an authorization code to an email sender. In response to retrieving an email message (e.g. stripped email message) from an email box 215, an email address owner may use an email client 220 to send, if desired, email message 500 including authorization code 250 to email sender 300. In one embodiment, email message 500 may be sent through email server 210. If the email address owner does not want email sender 300 to obtain an authorization code, then the email address owner may not respond to the request message from the email sender 300. The request code may have a limited time-to-live so that the user client does not continue to receive the same requests from a sender. In some embodiments, traditional email filters may also be employed within email server 210 to filter-out repeated requests for authorization codes from unwanted senders. In other embodiments, a user may provide authorization code 250 to a desired email sender 300 via other mediums of information exchange (e.g. floppy disk, telephone, and/or electronic facsimile).

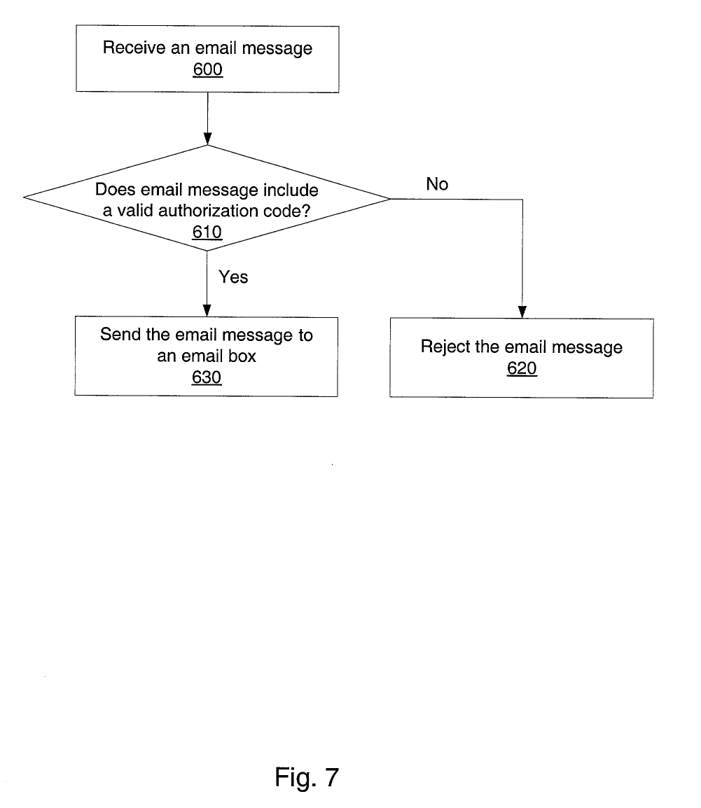

FIG. 7 illustrates one embodiment of a method for processing email messages to control unsolicited messages. An email server may receive an email message from an email sender as indicated at 600. The email server may determine whether a destination address of the email message includes a valid authorization code as indicated at 610.

In one embodiment, determining whether a destination address of the email message includes a valid authorization code may include parsing a destination address of the email message. The email server may query a database storing email addresses and their associated authorization codes for information on the destination address. If the email server determines that the email message does not include a valid authorization code for the destination address, the email server may reject the email message as indicated at 620. The email server may determine that the email message does not include a valid authorization code by finding a database record corresponding to the destination address, but not finding an authorization code included within the database record in the email message. The email server may determine that the email message does not include a valid authorization code by not finding a database record corresponding to the destination address. In the latter case, in one embodiment, the email server may reject the email message. In the latter case, in another embodiment, the email server may send the email message to the destination address. In one embodiment, the email server may delete the email message and send a reply message to the email sender. If the email server determines that the destination address corresponds to an email box and that the email message includes a valid authorization code for the email box, the email server may send the email message to the email box as indicated at 630.

The reply message may include information on how to obtain an authorization code of the email client. In one embodiment, the reply message may include a request code. The reply message may include, within a body, instructions on how to use the request code and a subject of an email message for requesting an authorization code. In one embodiment, the reply message may include instruction on how to affix (e.g. prefix delimited with a period) the request code to a destination address of an email message. In one embodiment, the reply message may include a time-to-live indicator indicating a length of time for which the request code is valid. If the time-to-live indicator expires, a new request code may be generated to replace the request code. In one embodiment, the email server may access the database to determine whether the request code has expired. A database record may include a timestamp field and a time-to-live field. The timestamp field may indicate the time at which the database record was created and the time-to-live filed may indicate the time-to-live for the request code. The email server may use the timestamp field and the time-to-live field to determine whether the request code has expired.

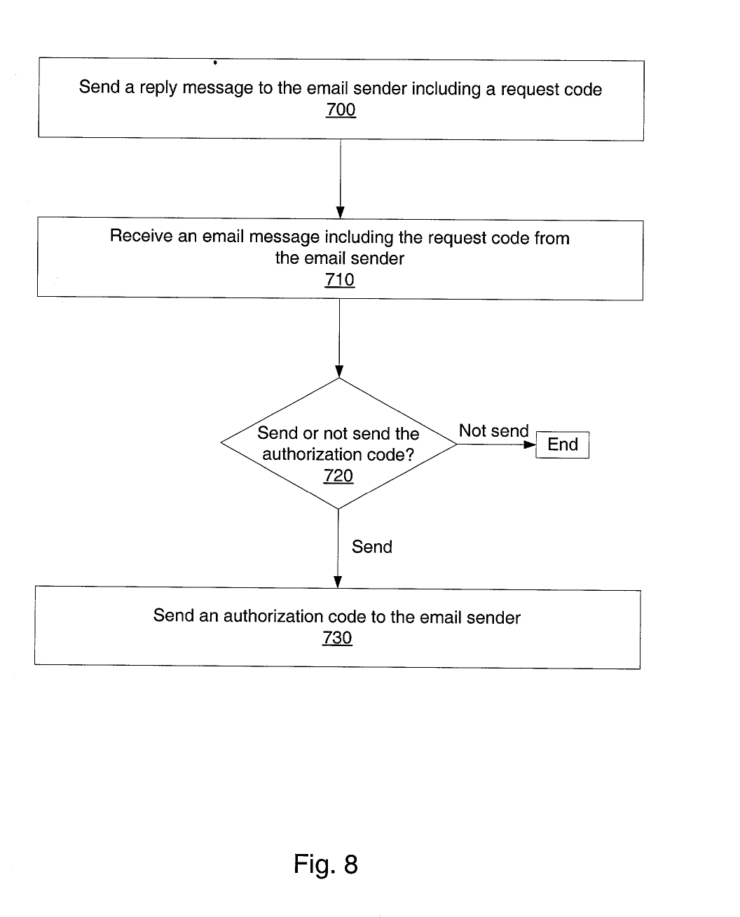

FIG. 8 illustrates one embodiment of a method for handling email messages that do not include valid authorization codes. An email server may receive an email message that does not include a valid authorization code as indicated at 700. Instead of sending the email message to an email address mail box, the email server may send a reply message to the email sender. In one embodiment, the reply message may include information on how to obtain an authorization code. In one embodiment, the reply message may include a request code corresponding the email address. In one embodiment, the reply message may include instructions on how to use the request code and a subject of an email message to request an authorization code. In one embodiment, the reply message may include a time-to-live indicator indicating a time at which the request code may expire. In another embodiment, the reply message may not contain the time-to-live indicator. In one embodiment, the email server may determine a request code for the email address. In one embodiment, to determine a request code for the email address, the email server may query a database storing information on email addresses and corresponding request codes.

After receiving the reply message, the email sender may send an email message including the request code to the email client to request an authorization code.

The email server may receive the email message as indicated at 710. The email server may determine that the email message includes a request code, for example, by querying the database. The email server may strip the email message of a body and attachments, if any. The email server may provide the stripped email message to an email box corresponding to the email address. An owner of the email address may retrieve the stripped message from the email box with an email client. The email address owner may use the stripped email message to determine whether to provide an authorization code to the email sender as indicated at 720. In one embodiment, the email address owner may examine a destination field and a subject field of the email message to make the determination. In one embodiment, the determination 720 may be made by human input to an email client application. If a determination is made to provide the authorization code to the email sender, the email client may send an authorization code to the email sender as indicated at 730. In one embodiment, the authorization code may be included in an email message that is sent to the email sender. In alternate embodiments, other methods may be used to provide the authorization codes to the email sender. For example, the code may be included in a telephone message or on a persistent storage medium (e.g. floppy disk) provided to the email sender.

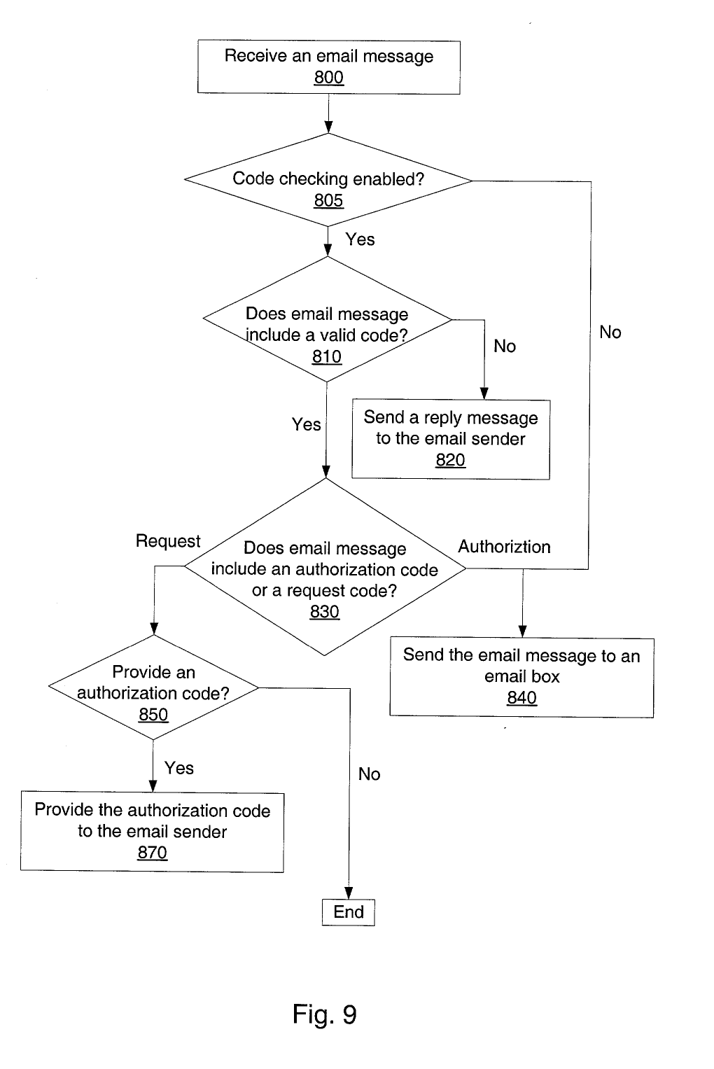

FIG. 9 illustrates one embodiment of a method for checking an email message for a valid code. An email server may receive an email message from an email sender as indicated at 800. The email server may determine whether code checking has been enabled as indicated at 805. In one embodiment, there may be an ‘enabled’ field in a database table indicating whether the use of codes is enabled for each record corresponding to each email address. The enabled field may be set to indicate that the use of codes is disabled for a record corresponding to the email address (i.e. code checking is disabled). In one embodiment, the owner of the email address may use a user interface to disable the use of codes by modifying the database record corresponding to the email address. In one embodiment, the user interface may be a web-based tool implementing user authentication (e.g. login with a username and a password) and encrypted communication for security.

The email server may determine whether code checking is disabled by accessing the database. In one embodiment, the email server may parse the email message to obtain a destination address. The email server may use the destination address from the email message to access the record corresponding to the destination address. If the email server determines that code checking is disabled, the email server may send the email message to an email box corresponding to the email address regardless of codes associated with the email address as indicated at 840.

If the email server determines that code checking is enabled, the email server may determine whether the email message includes a valid code (e.g. authorization codes and request codes) as indicated at 810. In one embodiment, the email server may use the destination address to query the database to determine whether the email message includes a valid code.

If the email message does not contain a valid code, the email server may send a reply message to the email sender as indicated at 820. In one embodiment, the reply message may include a request code and instructions on how to use the request code to obtain an authorization code. In one embodiment, the reply message may include a time-to-live indicator that indicates a time at which the request code will expire. In another embodiment, the email server may not send a reply message to the email sender. The email server may simply discard the email message.

If the email message does contain a valid code, the email server may determine if the code is an authorization code or a request code as indicated at 830. If the email message includes a valid authorization code, the email server may send the email message to the email box corresponding to the destination address of the email message as indicated at 840. In one embodiment, if the email message includes a valid request code, the email server may send at least a portion of the email message to the email client. In one embodiment, the portion may be only a subject and a source address of the email message.

The portion of the email message may be used to determine whether to provide an authorization code to the email sender as indicated at 850. In one embodiment, an owner of the destination address may make the determination. In other embodiments, there may be other methods to make the determination. In one embodiment, it may be determined to not provide an authorization code to the email sender as indicated at 860. In one embodiment, if it is determined to provide the email sender with an authorization code, the destination address owner may provide the authorization code to the email sender as indicated at 870.

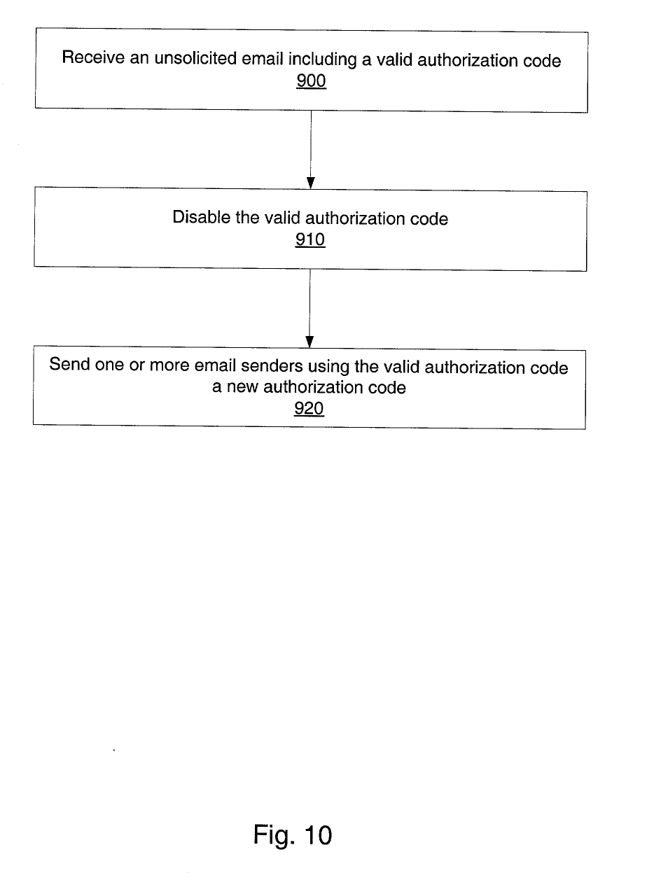

FIG. 10 illustrates one embodiment of handling a compromised authorization code. An unsolicited email handler may receive an email message from an email sender, as indicated at 900. The email message may include a valid authorization code and thus the unsolicited email handler may forward the email message to an email box corresponding to a destination address of the email message. An owner of an destination address may determine that the email message is unsolicited or that the sender is not someone who should have had a valid authorization code. The owner may disable the compromised authorization code as indicated at 910. The disabled code may continue to be stored to help prevent new codes from coinciding with the disabled code.

The disabled code may have been provided to one or more legitimate email senders and then compromised. For example, an unsolicited email sender (e.g. an advertiser) may have obtained a valid authorization code from a legitimate email sender. A new valid authorization code may be generated and provided to the one or more legitimate email senders, but not the email sender of the unsolicited email message, as indicated at 920. In one embodiment, the owner may use a secure web tool or user interface to disable one or more authorization codes and generate new authorization codes. In one embodiment, disabling authorization codes and generating new authorization codes may include maintaining a database of email addresses and codes corresponding to the email address.

The unsolicited email handler may block email messages containing the disabled code. In another embodiment, the unsolicited email handler may access a list (e.g. a database) of legitimate email senders provided with the original valid authorization code. The unsolicited email handler may automate disabling compromised authorization codes, generating new authorization codes, and providing new authorization codes to legitimate email senders.

Note that the systems and methods described above are merely examples. The methods may be implemented in software, hardware, or a combination thereof. The order of methods may be changed, and various elements may be added, reordered, combined, omitted, modified, etc. Also, the functionality of the unsolicited email handling system described herein may be applied to any email system. The particular systems illustrated herein are provided as non-limiting examples. For example, the unsolicited email handler may be implemented as a separate proxy server to a traditional email server.

In other embodiments, codes for email addresses may be included elsewhere in email messages besides the destination address. For example, a code may be included in a subject, body or attachment of an email message.

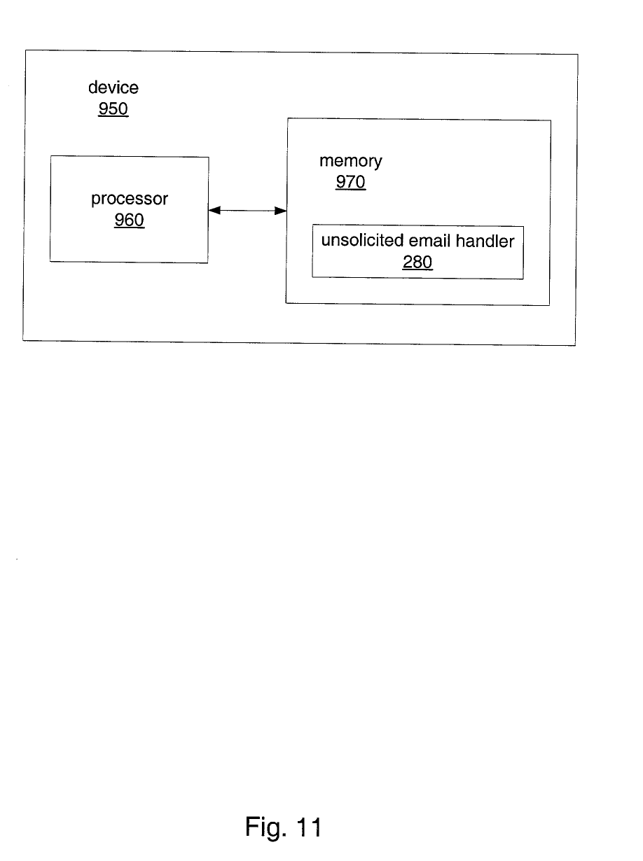

FIG. 11 illustrates one embodiment of a device, such as a server, configured to implement unsolicited email handler. Device 950 may include processor 960 and memory 970. Memory 970 may include program instructions executable by processor 960 to implement unsolicited email handler 280. In one embodiment, for example, device 950 may be, but is not limited to, a networked desktop computer, a workstation, or a server, for example.

Various embodiments may further include receiving, sending or storing instructions and/or data implemented in accordance with the foregoing description upon a computer-accessible medium or article of manufacture. Generally speaking, a computer-accessible medium or article of manufacture may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system comprising:
a plurality of email clients;
a server configured to:
receive an email message from a sender, wherein the email message comprises a destination address of one of the plurality of email clients;
determine if the email message comprises a valid authorization code; and
if the email message comprises a valid authorization code, provide the email message to the email client indicated by the destination address of the email message, and if the email message does not comprise a valid authentication code, not provide the email message to the email client indicated by the destination address of the email message.

2. The system as recited in claim 1, wherein the server is further configured access a database of authorization codes for email addresses to determine whether an authorization code provided with the email message is valid or invalid.

3. The system as recited in claim 1, wherein the server is further configured to, if the email message does not comprise a valid authorization code, send a reply email message to the sender of the email message, wherein the reply email message includes information for requesting a valid authorization code.

4. The system as recited in claim 3, wherein the information for requesting the valid authorization code includes a request code.

5. The system as recited in claim 4, wherein the information for requesting the valid authorization code further includes instructions on how to use the request code.

6. The system as recited in claim 4, wherein the information for requesting the valid authorization code further includes a time-to-live indicator corresponding to the request code, wherein the time-to-live indicator indicates a time at which the request code is scheduled to expire.

7. The system as recited in claim 4, wherein the request code is encoded in a non-text format.

8. The system as recited in claim 1, wherein the server is further configured to determine if the email message comprises a valid request code, wherein the valid request code identifies the email message as a request for a valid authorization code of an addressed client, and wherein if the email message comprises a valid request code, provide at least a portion of the email message to the email client indicated by the destination address of the email message.

9. The system as recited in claim 8, wherein, if the email message comprises a valid request code, the addressed email client is configured determine whether or not to send to send a valid authorization code to the sender in response to the email message including the valid request code.

10. The system as recited in claim 1, wherein, if the email message comprises a valid authorization code, the server is configured to provide the email message to the email client indicated by the destination address of the email message by storing the email message in an email box for the client.

11. The system as recited in claim 11, further comprising a database, wherein the database is configured to store one or more destination addresses and one or more authorization codes for each destination address, and wherein, to determine if the authorization code is a valid authorization code, the server is further configured to:
locate a destination address of the email message within the database; and
compare the one or more authorization codes corresponding to the destination address with the authorization code of the email message.

12. The system as recited in claim 11, wherein the database is further configured to store a request code for a destination address, wherein the request code is used to request an authorization code for the destination address.

13. The system as recited in claim 12, wherein the database is further configured to store a time-to-live indicator for the request code, wherein the time-to-live indicator indicates a time at which the request code is scheduled to expire.

14. A device, comprising:
a processor;
a memory operable to store program instructions, wherein the program instructions are executable by the processor to:
receive an email message from a sender, wherein the email message comprises a destination address corresponding to an email client;
determine if the email message comprises a valid authorization code; and
if the email message does not comprise a valid authorization code, not provide the message to the email client.

15. The device as recited in claim 14, wherein, if the email message does not comprise a valid authorization code, the program instructions are further executable to delete the email message.

16. The device as recited in claim 14, wherein the program instructions are further executable to, if the email message comprises a valid authorization code, provide the email message for access by the addressed email client.

17. The device as recited in claim 14, wherein the program instructions are further executable to, if the email message does not comprise the authorization code, send a reply email message to the sender of the email message, wherein the reply email message includes information for requesting a valid authorization code.

18. The device as recited in claim 17, wherein the information for requesting the authorization code includes a request code.

19. The device as recited in claim 18, wherein the information for requesting the authorization code further includes instructions on how to use the request code and a subject field of a request message to request an authorization code.

20. The device as recited in claim 18, wherein the request code is encoded in a non-text format.

21. The device as recited in claim 18, wherein the information for requesting the authorization code further includes a time-to-live indicator corresponding to the request code, wherein the time-to-live indicator indicates a time at which the request code is scheduled to expire.

22. The device as recited in claim 14, wherein the program instructions are further executable to, if the email message does not comprise the authorization code, determine if the email message comprises a valid request code, wherein the request code identifies the email message as a request for the authorization code of the client, and wherein if the email message comprises the request code, provide at least a portion of the email message to the email client indicated by the destination address of the email message.

23. The device as recited in claim 14, wherein the program instructions are further executable to, if the email message comprises an authorization code, determine if the authorization code is a valid authorization code by accessing a database of valid authorization codes.

24. The device as recited in claim 23, wherein, to determine if the authorization code is a valid authorization code, the program instructions are further executable to:
locate a destination address of the email message within the database;
retrieve one or more stored valid authorization codes from the database for the destination address; and
compare the one or more stored authorization codes from the database with the authorization code of the destination address.

25. The device as recited in claim 14, wherein the device is an email server.

26. The device as recited in claim 14, wherein the program instructions are further executable to determine if the email message comprises a valid authorization code by examining a username portion of the destination address.

27. A method comprising:
receiving an email message from a sender, wherein the email message comprises a destination address corresponding to an email client;
determining if the email message comprises a valid authorization code; and
if the email message does not comprise a valid authorization code, preventing the email message from reaching the email client indicated by the destination address of the email message.

28. The method as recited in claim 27, further comprising, if the email message does not comprise a valid authorization code, deleting the email message.

29. The method as recited in claim 27, further comprising, if the email message comprises a valid authorization code, providing the email message to the email client.

30. The method as recited in claim 27, further comprising, if the email message does not comprise a valid authorization code, sending a reply email message including information for requesting the authorization code to the sender of the email message.

31. The method as recited in claim 30, wherein the information for requesting the authorization code includes a request code.

32. The method as recited in claim 31, further comprising expiring the request code at a time indicated by a time-to-live indicator comprised by the information for obtaining the authorization code.

33. The method as recited in claim 27, further comprising:
determining if the email message comprises a valid request code identifying the email message as a request for a valid authorization code of the client; and
if the email message comprises a valid request code, providing at least a portion of the email message to the email client indicated by the destination address of the email message.

34. The method as recited in claim 33, further comprising, receiving user input indicating to send a valid authorization code in response to the message including the valid request code, wherein a valid authorization code is not sent if said user input is not received.

35. The method as recited in claim 27, further comprising accessing a database to determine if an authorization code of the email message is a valid authorization code.

36. The method as recited in claim 35, wherein determining if the authorization code is a valid authorization code comprises:
locating a destination address of the email message within the database;
retrieving one or more stored valid authorization codes from the database for the destination address; and
comparing the one or more stored authorization codes from the database with the authorization code of the destination address.

37. An article of manufacture comprising program instructions executable to implement:
receiving an email message from a sender, wherein the email message comprises a destination address corresponding to an email client;
determining if the email message comprises a valid authorization code; and
if the email message does not comprise a valid authorization code, preventing the email message from reaching the email client indicated by the destination address of the email message.

38. The article of manufacture as recited in claim 37, wherein the program instructions are further executable to implement, if the email message does not comprise the authorization code, deleting the email message.

39. The article of manufacture as recited in claim 37, wherein the program instructions are further executable to implement, if the email message comprises the authorization code, providing the email message for access by the addressed email client.

40. The article of manufacture as recited in claim 37, wherein the program instructions are further executable to implement, if the email message does not comprise the authorization code, sending a reply email message including information for requesting the authorization code to the sender of the email message.

41. The article of manufacture as recited in claim 40, wherein the information for requesting the authorization code includes a request code.

42. The article of manufacture as recited in claim 41, wherein the program instructions are further executable to implement expiring the request code at a time indicated by a time-to-live indicator comprised by the information for obtaining the authorization code.

43. The article of manufacture as recited in claim 37, wherein the program instructions are further executable to implement:
determining if the email message comprises a request code identifying the email message as a request for the authorization code of the client; and
if the email message comprises the request code, providing at least a portion of the email message to the email client indicated by the destination address of the email message.

44. The article of manufacture as recited in claim 43, wherein the program instructions are further executable to implement, providing a valid authorization code to the sender if instructed by the email client to provide a valid authorization code in response to the email message including the request code.

45. The article of manufacture as recited in claim 37, wherein the program instructions are further executable to implement, accessing a database to determine if an authorization code is a valid authorization code.
